(19) United States
(12) Patent Application Publication
(10) Pub. No.: US 2021/0159473 A1
(43) Pub. Date: May 27, 2021

(54) BATTERY PACK WATER CONDENSATION MITIGATION

(71) Applicant: GM GLOBAL TECHNOLOGY OPERATIONS LLC, Detroit, MI (US)

(72) Inventors: Taeyoung HAN, Bloomfield Hills, MI (US); Alok WAREY, Novi, MI (US); Chih-hung YEN, Bloomfield Hills, MI (US); Shailendra KAUSHIK, Novi, MI (US); Kuo-huey CHEN, Troy, MI (US); Marco J. GATTI, Grosse Ile, MI (US); Wonhee M. KIM, Royal Oak, MI (US)

(73) Assignee: GM GLOBAL TECHNOLOGY OPERATIONS LLC, Detroit, MI (US)

(21) Appl. No.: 16/695,865

(22) Filed: Nov. 26, 2019

(51) Int. Cl. H01M 2/10; B60L 50/64

(52) U.S. Cl. CPC H01M 2/1094; H01M 2220/20; H01M 2/1072; B60L 50/64

(57) ABSTRACT

A water condensation mitigation system for a battery pack having a battery housing system configured to generally surround and contain the battery pack. The battery housing system having a housing having a plurality of wall surfaces defining a housing volume. The housing volume being sized and shaped to contain the battery pack. The housing further having at least one aperture formed in at least one of the plurality of wall surfaces. A pressure valve member being operably mounted relative to the aperture of the housing that is configured to accommodate pack air volume changes and/or temperature changes in the housing volume.

### INTRODUCTION

This section provides background information related to the present disclosure which is not necessarily prior art.

The present disclosure relates to battery packs and, more particularly, to a water-condensation mitigation system for a battery pack by reducing the relative humidity inside a battery pack and balancing a pressure within the battery pack with ambient pressure.

Advantageously, battery packs of hybrid and electric vehicles maintain a high levels of durability and reliability. To ensure the desired life span of the battery and performance, battery packs are often equipped with a cooling system. However, the changing environmental conditions often causes water condensation in the battery pack, which can potentially lead to corrosion and electrical shorts. The present disclosure, in some aspects, mitigates the water condensation, minimizes the relative humidity inside the battery pack, and continuously equalizes the pressure within the battery pack with ambient conditions to minimize air exchange between the pack and the outside.

### SUMMARY

This section provides a general summary of the disclosure, and is not a comprehensive disclosure of its full scope or all of its features.

In certain aspects, the present disclosure relates to a water condensation mitigation system for a battery pack. The water condensation mitigation system includes a battery housing system configured to generally surround and contain the battery pack. The battery housing system has a housing including a plurality of wall surfaces defining a housing volume. The housing volume is sized and shaped to contain the battery pack. The housing further has at least one aperture formed in at least one of the plurality of wall surfaces. A pressure valve member is operably mounted relative to the aperture of the housing and is configured to accommodate pack air volume changes in the housing volume.

In certain aspects, the pressure valve member comprises a flexible diaphragm member operably mounted relative to the aperture of the housing. The flexible diaphragm member is configured to accommodate pack air volume changes in the housing volume through elastic deflection. In certain aspects, the flexible diaphragm member is impermeable to liquid water and water vapor.

In certain aspects, the water condensation mitigation system includes a shroud generally surrounding the flexible diaphragm member that is mounted to the housing and sized to protect the flexible diaphragm member during deflection. In certain aspects, the shroud includes one or more perforations sized to regulate a rate of reaction of the flexible diaphragm member.

In certain aspects, the pressure valve member includes a ventilated or breathable fabric membrane operably mounted relative to the aperture of the housing that is configured to permit transfer of air and water vapor therethrough and prevent or inhibit transfer of liquid water.

In certain aspects, the pressure valve member includes a smart valve member operably mounted relative to the aperture of the housing and configured to be biased in a closed position and operable to move to an opened position in response to a predetermined temperature, a predetermined pressure differential between an internal pressure within the housing volume and an external pressure outside the housing volume, or a combination thereof.

In certain aspects, the smart valve member includes a first member fixedly coupled to at least one of the plurality of wall surfaces and includes at least one ventilation hole, a second member moveable relative to the first member and configured to sealingly engage at least one of the plurality of wall surfaces for movement between a closed position and an opened position, an extension spring operably coupling the first member to the second member and biasing the second member into the closed position, and a compression spring operably engaging the first member and the second member. The compression spring is made of a shape memory alloy and configured to automatically urge the second member into the opened position in response to an increased temperature above a predetermined temperature, an increased pressure above a predetermined pressure, or a combination thereof.

In certain aspects, the pressure valve member includes a pair of one-way valve members each operably mounted relative to a corresponding aperture of the housing and configured to be biased in a closed position and operable to move to an opened position in response to a predetermined pressure differential. In certain aspects, the first of the pair of one-way valve members is operable to move to an opened position when an internal pressure within the housing volume is greater than an external pressure outside the housing volume, and the second of the pair of one-way valve members is operable to move to an opened position when the internal pressure within the housing volume is less than the external pressure outside the housing volume.

In certain aspects, the water condensation mitigation system can include a moisture absorber member disposed in fluid communication with a pressure valve member to remove moisture. In certain aspects, the moisture absorber member is made of a desiccant material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a partial cross-sectional view of a water condensation mitigation system for battery packs having a permeable patch member according to certain aspects of the present disclosure;

FIG. 2 is a graph illustrating accumulation of water condensation as a relationship of relative humidity and associated battery pack air temperature;

FIG. 3A illustrates a partial cross-sectional view of a water condensation mitigation system for battery packs having a diaphragm and a smart valve member according to certain aspects of the present disclosure;

FIG. 3B illustrates a partial cross-sectional view of a water condensation mitigation system for battery packs having a caged diaphragm and a smart valve member according to certain aspects of the present disclosure;

FIG. 4 is a cross-sectional view of a smart valve member according to certain aspects of the present disclosure in a closed position;

FIG. 5 is a cross-sectional view of the smart valve member of FIG. 4 in an opened position responsive to a temperature change;

FIG. 6 is a cross-sectional view of the smart valve member of FIG. 4 in an opened position responsive to a pressure change;

FIG. 7 illustrates a partial cross-sectional view of a water condensation mitigation system for battery packs having a pair of one-way valves and a smart valve member according to certain aspects of the present disclosure; and

FIG. 8 is a flowchart illustrating a design and operation methodology according to certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

With particular reference to the figures, according to the principles of the present teachings, a water-condensation mitigation system 10 is disclosed having a battery housing system 12 generally (or completely) surrounding and containing an exemplary battery pack 14. In some aspects, battery pack 14 can comprise one or more high-energy density, electrochemical cells, such as lithium ion batteries or any other battery system, such as those employed in a variety of consumer products and vehicles, such as Electric Vehicles (EVs) and Hybrid Electric Vehicles (HEVs).

It should be understood that in some variations the battery pack 14 can include other battery system componentry, such as, but not limited to, a cooling system, a coolant pipe, a coolant plate, a case, a cover, a package, a cell, a body, and combinations thereof. In some variations, battery pack 14 can comprise one or more battery cells. In some aspects, battery pack 14 is a system as disclosed in commonly owned U.S. Pat. No. 10,487,235, which is hereby incorporated and made part of the present disclosure.

As can be appreciated, battery packs of hybrid and electric vehicles must have a high level of durability and reliability. To ensure the desired life span of the battery and its associated performance, today's battery packs may be equipped with a cooling system to maintain a desired operating temperature. However, environmental conditions often cause water condensation and corrosion in conventional battery packs. This corrosion can consequently result in the potential for an electric short or, in some cases, a thermal runaway event. Therefore, water condensation should be prevented to lower the risk of corrosion and electric shorts. As illustrated in FIG. 2, a graph is provided having a pack air temperature in degrees Celsius (° C.) on the x-axis 202 and dew point temperature in degrees Celsius (° C.) on the y-axis 204 for four relative humidity values of 20%, 40%, 60%, and 80% as given in box 206 wherein water condensation 208 can occur above a coolant temperature 2010.

According to the present disclosure, water-condensation mitigation system 10 is configured to mitigate water condensation within a battery housing system 12 to reduce and/or maintain the relative humidity and/or dew point inside the battery housing system 12 at a sufficient level to reduce and/or eliminate water condensation in or on battery pack 14. Moreover, in some aspects, the water-condensation mitigation system 10 is configured to balance a pressure within the battery housing system 12 with an ambient pressure outside of the battery housing system 12.

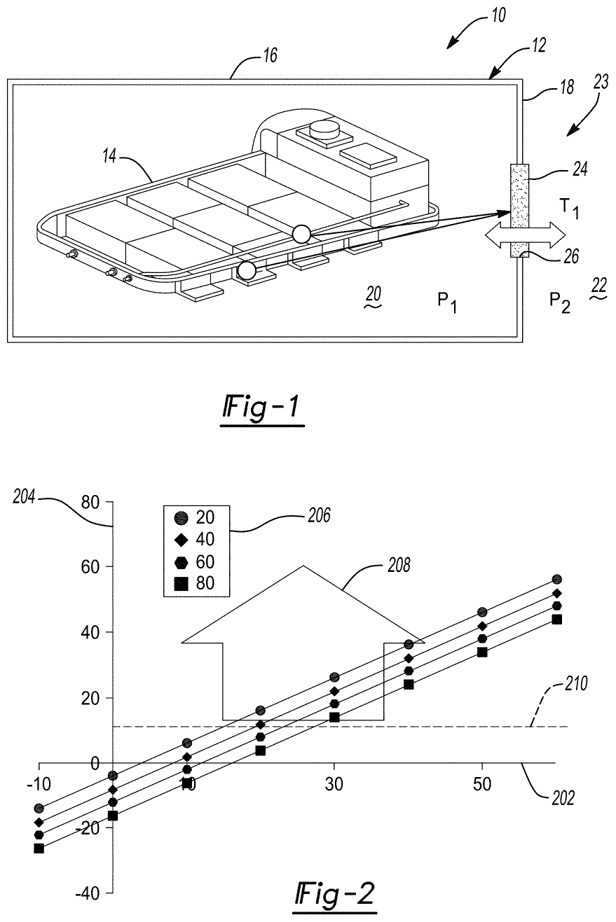

By way of illustration, as shown in Table 1, pressure within a battery pack, denoted as P1 in FIGS. 1, 3A, 3B, and 7, varies as ambient temperature varies. More particularly, responsive to an environmental temperature (i.e. ambient temperature) changes relative to a baseline exemplary temperature of about 25° C. (i.e. illustrative baseline), internal pack pressure, P1, within an enclosed structure increases to about 1.73 psi at 60° C. and decreases to about −2.72 psi at −30° C. Likewise, if the enclosed structure is permitted to vary in volume in response to the change in environmental temperature, the air volume would increase by about 11.8% at 60° C. and decrease by about 18.5% at −30° C. from a relative pressure at about 25° C. In accordance with the teachings of the present disclosure, these pressure and volume characteristics can be harnessed to remove moisture from within battery housing system 12 and ensure pressure equalization with an external environmental pressure, denoted as P2, according to the present disclosure.

TABLE 1

| | Ambient Temperature (° C.) | | | | | | | | | |
|---|---|---|---|---|---|---|---|---|---|---|
| | −30 | −20 | −10 | 0 | 10 | 20 | 30 | 40 | 50 | 60 |
| Pack | −2.72 | −2.22 | −1.73 | −1.23 | −0.74 | −0.25 | 0.25 | 0.74 | 1.23 | 1.73 |
| Pressure | | | | | | | | | | |
| Change (psi) | | | | | | | | | | |
| Pack Air | −18.5% | −15.1% | −11.8% | −8.4% | −5.0% | −1.7% | 1.7% | 5.0% | 8.4% | 11.8% |
| Volume | | | | | | | | | | |
| Change (%) | | | | | | | | | | |

With particular reference to FIG. 1, according to some aspects of the present teachings as noted herein, water-condensation mitigation system 10 can comprise a battery housing system 12 generally (or completely) surrounding and containing battery pack 14. In certain aspects, battery housing system 12 can comprise an enclosure having a housing 16 having a plurality of wall surfaces 18 defining a housing volume 20. It should be appreciated that the particular size, shape, and configuration of housing 16 can vary according to the specific design parameters of the vehicle or application in which water-condensation mitigation system 10 is to be used. It should be understood that the size, shape, and configuration of housing 16 in the several views should be regarded as schematically shown. In certain aspects, the battery pack 14 is disposed within and enclosed by housing 16 such that battery housing system 12 is thus configured to control and regulate air, moisture, pressure, and/or other parameters between the housing volume 20 and an external space or volume 22. External volume 22 is depict as any airspace, environment, or region outside of the housing volume 20. As previously noted, the pressure of housing volume 20 is depicted as P1 and the pressure of external volume 22 is depicted as P2.

In certain aspects, battery housing system 12 includes a pressure valve system 23 being configured to accommodate and equalize a pressure differential (ΔP) between internal pressure P1 and external pressure P2. As will be described herein, pressure valve system 23 can comprise, singly or in combination, a ventilated or breathable fabric membrane, a flexible diaphragm member, a smart pressure valve, one or more one-way valves, or systems similar thereto.

In certain aspects, the pressure valve system 23 comprises at least one ventilated or breathable fabric membrane 24 disposed, mounted, and/or secured within or adjacent an aperture 26 formed in at least one wall surface 18 of housing 16. In some configurations, the breathable fabric membrane 24 is a Gore-Tex®. In this way, breathable fabric membrane 24 is configured to permit water vapor and air transfer between housing volume 20 and external volume 22. In certain aspects, breathable fabric membrane 24 can prevent and/or inhibit transfer of liquid water therebetween. Transfer of air and water vapor (depicted at T1) can be driven by a pressure differential between P1 and P2—namely, if P1 within housing volume 20 is greater than P2 in external volume 22, then air and water vapor can freely transfer from within housing volume 20 to external volume 22 and vice versa until pressure equilibrium is achieved between P1 and P2. In this way, water vapor can be expelled from housing volume 20 in response to changing pressure and/or temperature. It is noted, as described herein, that temperature changes within battery housing system 12 can serve to cause an air volume change through breathable fabric membrane 24 as a result of corresponding changes in pressure.

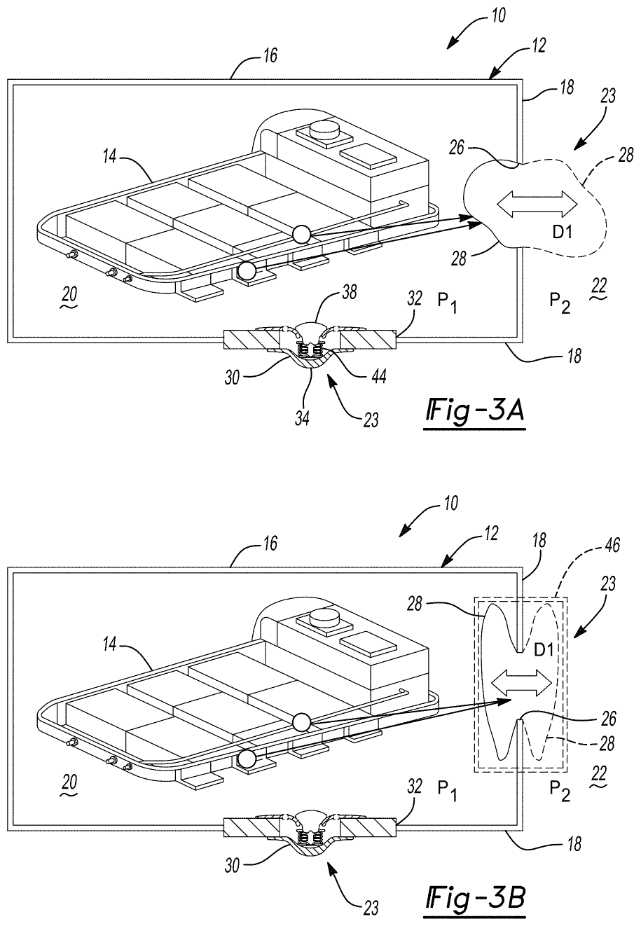

In certain aspects, as illustrated in FIGS. 3A and 3B, the pressure valve system 23 comprises at least one flexible diaphragm member 28 disposed, mounted, and/or secured within or adjacent aperture 26 formed in at least one wall surface 18 of housing 16. In some configurations, the flexible diaphragm member 28 is made of a flexible material sufficient to accommodate pack air volume changes in housing volume 20. That is, in certain aspects, flexible diaphragm member 28 is designed to equalize pressure while preventing the ingress of water vapor and contaminants during normal operations via elastic deflection. In certain aspects, flexible diaphragm member 28 is made of a silicon rubber material, impermeable to liquid water and water vapor, that is elastically deformable to prevent rupture in normal operation, but allow rupture during thermal runaway events. In this way, flexible diaphragm member 28 is configured to prevent and/or inhibit water vapor and air transfer between housing volume 20 and external volume 22. Deflection of flexible diaphragm member 28 (depicts at D1) can be driven by a pressure differential (ΔP) between P1 and P2—namely, if P1 within housing volume 20 is greater than P2 in external volume 22, then flexible diaphragm member 28 is deflected outward of housing 16 (illustrated with dashed lines) and vice versa (illustrated with solid line) until pressure equilibrium is achieved between P1 and P2. In this way, normal pressure differential is accommodated through a variable volume change of housing volume 20. It is also noted that temperature changes within battery housing system 12 and/or battery pack 14 can serve to cause a pressure differential resulting in deflection of flexible diaphragm member 28.

In certain aspects, deflection of flexible diaphragm member 28 can be protected by employing an optional cage or protective shroud 46 generally surrounding and enclosing flexible diaphragm member 28. Shroud 46 can be perforated or otherwise configured to permit free expansion of flexible diaphragm member 28; however, these perforations can be tailored to regulate the rate of reaction of flexible diaphragm member 28 by permitting a rate change of opposing air pressure to be exerted on the flexible diaphragm member 28 during deflection. In this way, shroud 46 should be sized to permit an anticipated maximum deflection of flexible diaphragm member 28 during operation (for one or both deflection directions) and prevent diaphragm deflection that may penetrate or damage adjacent components. As indicated in Table 1, in some aspects, flexible diaphragm member(s) 28 can accommodate a total volume displacement of +12% to −18%. It is again noted that a plurality of flexible diaphragm members 28 can be used in accordance with the present teachings.

However, it should be recognized that in case of an unexpected thermal runaway event (where rapid heating of the battery pack 14 occurs and temperature and pressure rapidly rise), flexible diaphragm member 28 can be configured such that it ruptures and quickly permits escape of heat and pressure from within housing volume 20 to external volume 22.

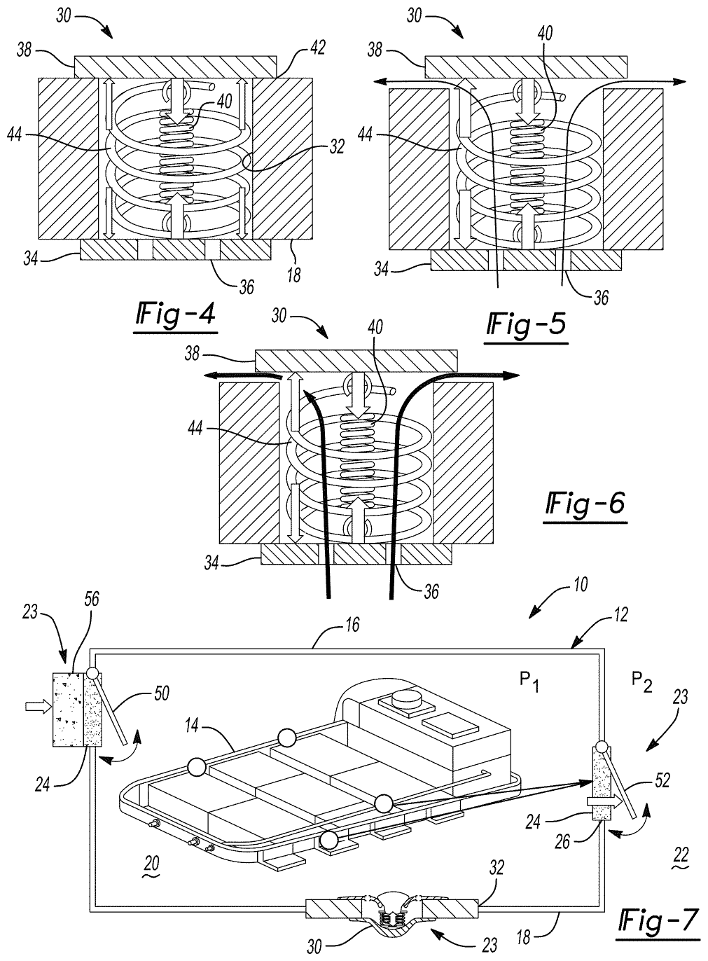

With reference to FIGS. 3-8, in certain aspects, the pressure valve system 23 comprises at least one smart valve member 30 disposed, mounted, and/or secured within or adjacent aperture 32 formed in at least one wall surface 18 of housing 16. Smart valve member 30 is schematically illustrated in FIGS. 4-6. However, it should be understood that smart valve member 30 can be responsive to material characteristic changes (as described in certain aspects herein) or sensor-based characteristic changes. That is, in certain aspects, smart valve member 30 can be an electronic system responsive to sensors operably coupled to a control system that outputs a control signal to a moveable valve member. In this way, sensors, being responsive to temperature, pressure, and/or other operational parameters, can output signals to permit the control system to detect and command a need to open the moveable valve member, thereby permitting venting or fluid communication within housing 16. In this way, electronic-based automatic control can be achieved.

In certain aspects, smart valve member 30 can be passive, thereby operational without a power supply, and includes a first member 34 that is fixedly coupled or otherwise secured, integrally formed, or constructed to wall surface 18 of housing 16. It should be understood that in certain configurations, first member 34 can be fixedly coupled to an exterior side of wall surface 18 or an interior side of wall surface 18 depending on a desired flow direction during operation. In certain aspects, first member 34 is generally sized to conceal or cover a side surface adjacent aperture 32 and fixed in position relative to wall surface 18. In certain aspects, first member 34 includes one or more ventilation holes 36 that permit transfer of air and water vapor therethrough.

In certain aspects, smart valve member 30 includes a second member 38 this is moveably retained adjacent wall surface 18 opposite first member 34. That is, first member 34 and second member 38 are positioned on opposing sides of wall surface 18 and sized to generally conceal or cover aperture 32. Second member 38 is moveable relative to first member 34 as herein described. In certain aspects, smart valve member 30 is actuated in response to temperature and pressure. In this way, an extension spring 40 is coupled between first member 34 and second member 38. In this way, extension spring 40 extends within aperture 32. Extension spring 40 biases first member 34 and second member 38 toward each other as indicated by the arrows into a closed position. The closed position being defined by sealing engagement of the second member 38 with wall surface 18 of housing 16 at 42. Smart valve member 30 further includes a compression spring 44 positioned between first member 34 and second member 38 in contact therewith. Compression spring 44 extends within aperture 32 and, in certain aspects, surrounds and is coaxial with extension spring 40. In certain aspects, extension spring 40 can be made of stainless steel, and compression spring 44 can be made of a shape memory alloy (SMA). In this way, SMA compression spring 44 can be stiff when at or above a predetermined temperature and can be compliant below the predetermined temperature. It should be understood that alternative shape memory effects can be employed, such as, but not limited to, one-way memory effect or two-way memory effect.

Accordingly, in operation, as illustrated in FIG. 4, during cold temperatures or temperatures below a predetermined temperature, the SMA compression spring 44 is generally compliant and its biasing force is low. Therefore, smart valve member 30 is urged into a closed position because the biasing force of extension spring 40 is greater than the combined force of SMA compression spring 44 and any pressure differential between P1 and P2.

However, as illustrated in FIG. 5, if the temperature within housing volume 20 increases above a predetermined temperature (e.g. due to excessive heat during normal operation and/or thermal runaway event), the temperature of SMA compression spring 44 will similarly be increased resulting in an increase in spring stiffness. Once the combined force of SMA compression spring 44 and any pressure differential between P1 and P2 is greater than the biasing force of extension spring 40, second member 38 is urged away from wall surface 18 into an opened position defined by a non-sealing engagement at 42. Accordingly, air is permitted to transfer through ventilation holes 36, aperture 32, and the gap formed at 42.

Similarly, as illustrated in FIG. 6, if the pressure differential between P1 and P2 is sufficiently high (even if temperature within housing 20 remains substantially unchanged or, alternatively, if pressure increases rapidly due to a thermal runaway event), the combined force of SMA compression spring 44 and the pressure differential between P1 and P2 can be greater than the biasing force of extension spring 40, thereby resulting in second member 38 being urged away from wall surface 18 to form the gap at 42. Therefore, it should be understood that smart valve member 30 can be opened in response to an increase in temperature above a predetermined temperature and/or a sufficient pressure differential (ΔP) between P1 and P2. The specific temperature at which smart valve member 30 is opened can be set by the combined relationship of the biasing force of extension spring 40 and the temperature response profile of the SMA compression spring 44.

It should be understood that in aspects where smart valve member 30 is employed in combination with flexible diaphragm member 28 (and/or with shroud 46), it may be desirable to configure smart valve member 30 to operate in response to pressure differentials that generally equal the pressure differential that will result in the maximum desired deflection of flexible diaphragm member 28. In this way, smart valve member 30 may be suitable to serve to protect the integrity and operation of flexible diaphragm member 28 and prevent undesirable plastic deformation and/or rupture of flexible diaphragm member 28.

It should also be understood that in aspects where smart valve member 30 is employed, a diagnostic warning or alert can be displayed to a vehicle occupant when smart valve member 30 has been triggered or otherwise actuated, or when a predetermined operational parameter has been exceeded (i.e. excessive temperature, pressure, and the like), even if smart valve member 30 is not actuated. This alert can be achieve using sensors and/or other switches that are actuated in concert with actuation of smart valve member 30 or upon detection of an operational parameter. Such alerts or safety notifications can be useful in alerting vehicle occupants of a dangerous event (i.e. a thermal runaway, battery pack fire, imminent explosion, etc.).

In certain aspects, as illustrated in FIG. 7, the pressure valve system 23 comprises at least a pair of one-way valves 50, 52 disposed, mounted, and/or secured within or adjacent apertures 26 formed in at least one wall surface 18 of housing 16. In some configurations, one-way valves 50, 52 are each responsive to a pressure differential between P1 and P2. More particularly, in some aspects, one-way valve 50 can be biased in a closed position and movable or operable to open when P2 is greater than P1 (i.e. inlet one-way valve 50). Likewise, in some aspects, one-way valve 52 can be biased in a closed position and movable or operable to open when P1 is greater than P2 (i.e. outlet one-way valve 52). Accordingly, one-way valve 50 can automatically actuate to permit ingress of air into housing volume 20 in response to low pressure within housing volume 20 and one-way valve 52 can automatically actuate to permit egress of air out of housing volume 20 in response to high pressure within housing 20. It should be noted that the set actuation pressure differential for one-way valve 50 and one-way valve 52 can be different pressures or the same pressure, as desired.

In some aspects, one or more of one-way pressure valves 50, 52 can include at least one ventilated or breathable fabric membrane 24 disposed, mounted, and/or secured within or adjacent aperture 26 as described herein. Moreover, particularly in connection with inlet one-way valve 50, a moisture absorber member 56 can be disposed within aperture 26 or within an air passage leading to aperture 26 of inlet one-way valve member 50 (i.e. in fluid communication therewith) to serve to remove moisture from air entering housing volume 20 of housing 16. In some aspects, moisture absorber member 56 can be made of a hygroscopic material, such as, but not limited to, calcium chloride (CaCl₂(H₂O)ₓ) or other desiccant material. It should be noted that smart valve member 30 can optionally be employed to provide additional pressure and/or temperature control as described herein. Moreover, it should be noted that moisture absorber member 56 can be used in combination with other pressure valve system 23 configurations.

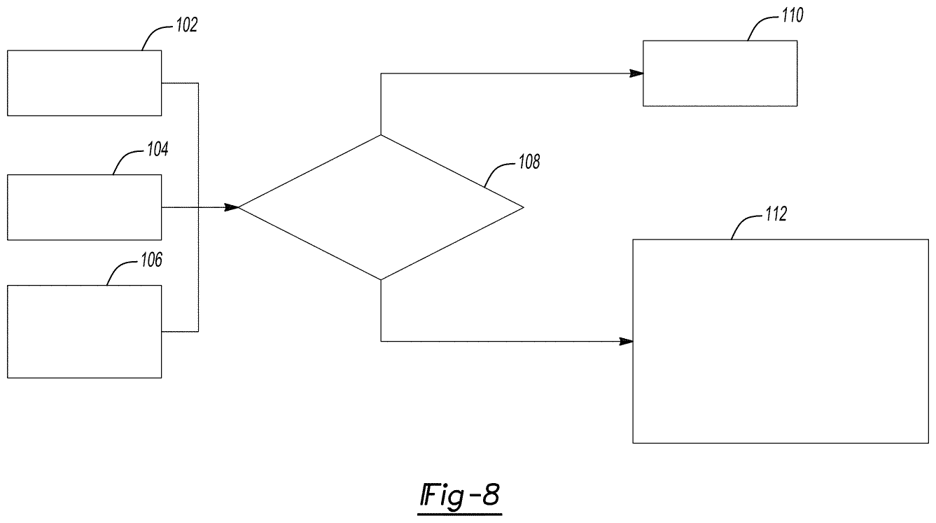

With reference to FIG. 8, in some aspects, in order to design and configure water-condensation mitigation system 10 one can consider the ambient temperature 102, ambient pressure 104, and battery pack operating temperatures 106 to calculate or determine a pack air volume change and pressure 108. These parameters can be used to compare a pop-out pressure (Pₒ) which may be indicative of a thermal runaway. The smart valve member can be configured to actuate/open when the pressure differential (ΔP) between P1 and P2 is greater than the pop-out pressure (Pₒ) (e.g. ΔP>Pₒ) and/or temperature is greater than the thermal runaway temperature at 110. If the pressure differential (ΔP) remains less than the pop-out pressure (Pₒ) (e.g. ΔP<Pₒ) and temperature remains less than the thermal runaway temperature, then normal operation parameters can be determined at 112. Such normal operation parameters can include i) identifying required air volume change in the battery pack to properly size the diaphragms, ii) determining the number of diaphragm structures, iii) selecting the material for the diaphragms that is flexible and has a rupture at a pressure sufficiently high (i.e. greater than 1 to 2 psi, for example), iv) installing the diaphragms and smart pressure valves, and the like.

According to the principles of the present teachings, water-condensation mitigation system 10 is provided that in some aspects includes a flexible diaphragm member with an optional smart valve member that provide continuous pressure equalization to help protect the battery housing against excessive over- or under-pressure during the life of the battery pack. The present disclosure further prevents and/or inhibits damp air in the housing volume and mitigates water condensation in the battery pack under various operating conditions. Smart valve members further enable large amounts of gasses to be expelled in a short timeframe in case of a thermal runaway event inside the battery pack.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A water condensation mitigation system for a battery pack, the water condensation mitigation system comprising:
a battery housing system configured to generally surround and contain the battery pack, the battery housing system having a housing having a plurality of wall surfaces defining a housing volume, the housing volume being sized and shaped to contain the battery pack, the housing further having at least one aperture formed in at least one of the plurality of wall surfaces; and
a pressure valve member being operably mounted relative to the aperture of the housing, the pressure valve member being configured to accommodate pack air volume changes in the housing volume.

2. The water condensation mitigation system according to claim 1 wherein the pressure valve member comprises a flexible diaphragm member being operably mounted relative to the aperture of the housing, the flexible diaphragm member being configured to accommodate pack air volume changes in the housing volume through elastic deflection.

3. The water condensation mitigation system according to claim 2 wherein the flexible diaphragm member is impermeable to liquid water and water vapor.

4. The water condensation mitigation system according to claim 2 further comprising:
a shroud generally surrounding the flexible diaphragm member, said shroud being mounted to the housing, the shroud being sized to protect the flexible diaphragm member during deflection.

5. The water condensation mitigation system according to claim 4 wherein the shroud comprises one or more perforations sized to regulate a rate of reaction of the flexible diaphragm member.

6. The water condensation mitigation system according to claim 1 wherein the pressure valve member comprises a ventilated or breathable fabric membrane operably mounted relative to the aperture of the housing, the ventilated or breathable fabric membrane being configured to permit transfer of air and water vapor therethrough and prevent or inhibit transfer of liquid water.

7. The water condensation mitigation system according to claim 6 wherein the ventilated or breathable fabric membrane comprising GORE-TEX.

8. The water condensation mitigation system according to claim 1 wherein the pressure valve member comprises a smart valve member operably mounted relative to the aperture of the housing, the smart valve member being configured to be biased in a closed position and operable to move to an opened position in response to a predetermined temperature, a predetermined pressure differential between an internal pressure within the housing volume and an external pressure outside the housing volume, or a combination thereof.

9. The water condensation mitigation system according to claim 8 wherein the smart valve member comprises:
a first member being fixedly coupled to at least one of the plurality of wall surfaces, the first member having at least one ventilation hole;
a second member being moveable relative to the first member, the second member being configured to sealingly engage at least one of the plurality of wall surfaces for movement between a closed position and an opened position;
an extension spring operably coupling the first member to the second member and biasing the second member into the closed position; and
a compression spring operably engaging the first member and the second member, the compression spring being made of a shape memory alloy and configured to automatically urge the second member into the opened position in response to an increased temperature above a predetermined temperature, an increased pressure above a predetermined pressure, or a combination thereof.

10. The water condensation mitigation system according to claim 1 wherein the pressure valve member comprises a pair of one-way valve members, each of the one-way valve members being operably mounted relative to a corresponding aperture of the housing, each of the one-way valve members being configured to be biased in a closed position and operable to move to an opened position in response to a predetermined pressure differential.

11. The water condensation mitigation system according to claim 10 wherein a first of the pair of one-way valve members is operable to move to an opened position when an internal pressure within the housing volume is greater than an external pressure outside the housing volume, and a second of the pair of one-way valve members is operable to move to an opened position when the internal pressure within the housing volume is less than the external pressure outside the housing volume.

12. The water condensation mitigation system according to claim 11 further comprising a moisture absorber member disposed in fluid communication with a pressure valve member to remove moisture, the moisture absorber member being made of a desiccant material.

13. A water condensation mitigation system comprising:
a battery pack;
a battery housing system configured to generally surround and contain the battery pack having a housing having a plurality of wall surfaces defining a housing volume, the housing volume being sized and shaped to contain the battery pack, the housing further having at least one aperture formed in at least one of the plurality of wall surfaces; and
a pressure valve member being operably mounted relative to the aperture of the housing, the pressure valve member being configured to accommodate pack air volume changes in the housing volume.

14. The water condensation mitigation system according to claim 13 wherein the pressure valve member comprises a flexible diaphragm member being operably mounted relative to the aperture of the housing, the flexible diaphragm member being configured to accommodate pack air volume changes in the housing volume through elastic deflection and impermeable to liquid water and water vapor.

15. The water condensation mitigation system according to claim 14 further comprising:
a shroud generally surrounding the flexible diaphragm member, said shroud being mounted to the housing, the shroud being sized to protect the flexible diaphragm member during deflection.

16. The water condensation mitigation system according to claim 13 wherein the pressure valve member comprises a ventilated or breathable fabric membrane operably mounted relative to the aperture of the housing, the ventilated or breathable fabric membrane being configured to permit transfer of air and water vapor therethrough and prevent or inhibit transfer of liquid water.

17. The water condensation mitigation system according to claim 13 wherein the pressure valve member comprises a smart valve member operably mounted relative to the aperture of the housing, the smart valve member being configured to be biased in a closed position and operable to move to an opened position in response to a predetermined temperature, a predetermined pressure differential between an internal pressure within the housing volume and an external pressure outside the housing volume, or a combination thereof.

18. The water condensation mitigation system according to claim 17 wherein the smart valve member comprises:
a first member being fixedly coupled to at least one of the plurality of wall surfaces, the first member having at least one ventilation hole;
a second member being moveable relative to the first member, the second member being configured to sealingly engage at least one of the plurality of wall surfaces for movement between a closed position and an opened position;
an extension spring operably coupling the first member to the second member and biasing the second member into the closed position; and
a compression spring operably engaging the first member and the second member, the compression spring being made of a shape memory alloy and configured to automatically urge the second member into the opened position in response to an increased temperature above a predetermined temperature, an increased pressure above a predetermined pressure, or a combination thereof.

19. The water condensation mitigation system according to claim 13 wherein the pressure valve member comprises a pair of one-way valve members, each of the one-way valve members being operably mounted relative to a corresponding aperture of the housing, a first of the pair of one-way valve members is operable to move to an opened position when an internal pressure within the housing volume is greater than an external pressure outside the housing volume, and a second of the pair of one-way valve members is operable to move to an opened position when the internal pressure within the housing volume is less than the external pressure outside the housing volume.

20. The water condensation mitigation system according to claim 13 further comprising a moisture absorber member disposed in fluid communication with the pressure valve member to remove moisture, the moisture absorber member being made of a desiccant material.
